(19) United States
(12) Patent Application Publication
(10) Pub. No.: US 2007/0256900 A1
(43) Pub. Date: Nov. 8, 2007

(54) Disk Brake

(75) Inventors: Eugen Kloos, Bensheim (DE); Frank Beyer, Mannheim (DE)

Correspondence Address: FRIEDRICH KUEFFNER, 317 MADISON AVENUE, SUITE 910, NEW YORK, NY, 10017, US

(73) Assignee: WABCO RADBREMSEN GMBH, Mannheim (DE)

(21) Appl. No.: 10/591,510

(22) PCT Filed: Feb. 21, 2005
(86) PCT No.: PCT/EP05/01791

§ 371 Date: May 21, 2007

(30) Foreign Application Priority Data
Mar. 1, 2004 (DE) 10 2004 009 123.4

(51) Int. Cl. F16D 55/22; F16D 55/02

(52) U.S. Cl. 188/71.3; 188/72.1; 188/72.4

(57) ABSTRACT

The invention relates to a disk brake which comprises a brake disk (4), having a preferred running direction (D), a first bake shoe (2), having a first center of gravity (S1) on a first side of the brake disk, a second brake shoe (3), having a second center of gravity (S2) on a second side of the brake disk, and a caliper (1) for transmitting the braking forces produced by the second brake shoe to the first side of the brake disk. A first caliper arm (1.1) is located on the first side of the brake disk, and a second caliper arm (1.2) on the second side of the brake disk. A brake application device (5) has a central axis (N) which is perpendicular to the brake disk and is adapted to force the first brake shoe against the brake disk. The second center of gravity, both in the position of rest and when the brake is actuated, is off-set by a predetermined first path (V) in the direction of a brake disk run-out side corresponding to the preferred running direction of the brake disk. The two caliper arms are off-set from each other by a predetermined second path (W) in the direction of the brake disk run-out side. According to the invention, a linking device (1.3, 1.4) interlinking the caliper arms is located radially closer to the brake disk on the brake disk run-out side than on the run-in side.

The invention relates to a disk brake with
a brake disk that has a preferred direction of rotation;
a first brake pad with a first center of gravity on a first side of the brake disk;
a second brake pad with a second center of gravity on a second side of the brake disk;
a caliper for transmitting the braking forces generated by the second brake pad to the first side of the brake disk, with a first caliper arm on the first side of the brake disk and a second caliper arm on the second side of the brake disk; and
a clamping device, which has a center axis perpendicular to the brake disk and is designed to force the first brake pad against the brake disk; wherein
the second center of gravity, both in the position of rest of the brake and when the brake is actuated, is offset relative to the first center of gravity by a predetermined first distance in the direction of a brake disk run-out side corresponding to the preferred direction of rotation of the brake disk.

Apart from the aforementioned displacement offset of the center of gravity, a disk brake of this type is known from U.S. Pat. No. 5,022,500.

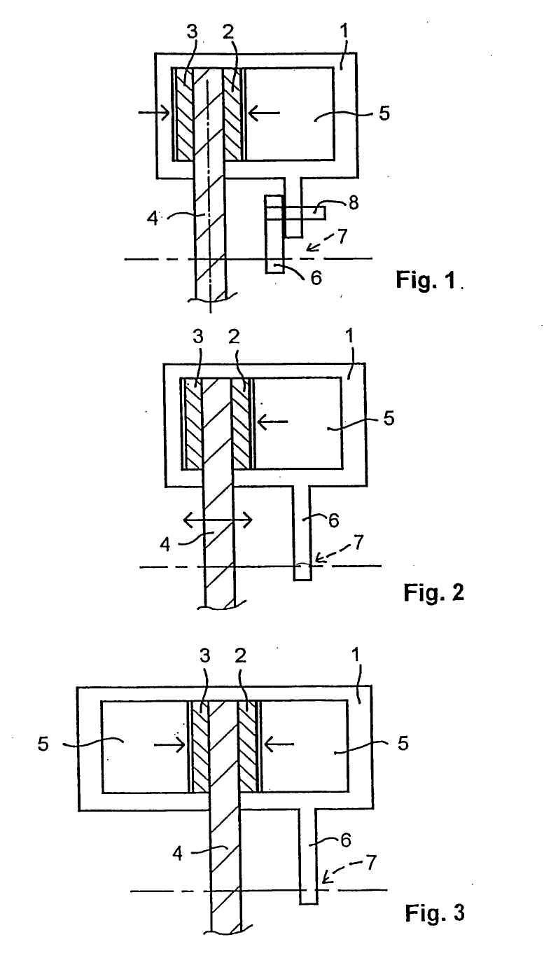

In general, disk brakes are distinguished according to their design and mode of operation with respect to the arrangement of the clamping device in the caliper. Examples are shown in FIGS. 1 to 4.

FIG. 1 shows a schematic sectional view of a sliding caliper disk brake with one-sided clamping by the reactive-force principle.

FIG. 2 shows a schematic sectional view of a fixed caliper disk brake with one-sided clamping by the reactive-force principle with floating brake disk.

FIG. 3 shows a schematic sectional view of a fixed caliper disk brake with a two-sided clamping device and a fixed brake disk.

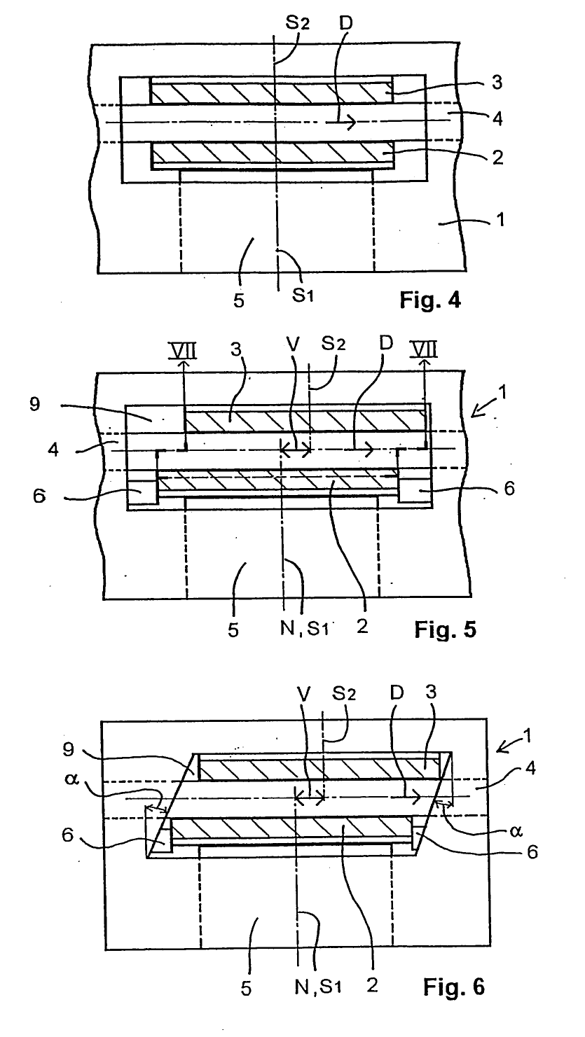

FIG. 4 shows a schematic top view in partial section of a disk brake.

Although the problems in question are discussed below with reference to a sliding caliper disk brake, all of the explanations also apply—in an analogous sense—to caliper disk brakes of the hinged type or fixed type with one-sided or two-sided clamping if a brake pad is directly held, guided, and/or supported on the free, i.e., unsupported, caliper arm. The free arm is the arm which absorbs the peripheral braking forces on this side and transmits them, via the bridge part that spans the brake disk, to the caliper's other side, on which the arm of the caliper on that side is joined with a fixed part. In other words, the invention is not limited to sliding caliper disk brakes.

In accordance with the prior art schematically illustrated in FIGS. 1 to 4, the disk brake has a caliper 1, which embraces a brake disk 4 with its two caliper arms and is equipped with at least one clamping device 5 mounted on one side of the brake disk 4 for forcing brake pads 2, 3, which are supported and guided in the caliper arms, against the brake disk 4 on both sides of the brake disk 4. The brake pads 2, 3 are held/guided in such a way that they lie opposite each other, and when displacement occurs in the direction of the brake disk, their centroidal axes or centers of gravity S1, S2 (FIG. 4) lie one above the other and meet the plane of the brake disk perpendicularly.

In this regard, the caliper 1 is connected with a vehicle part 7 (not shown), which is referred to as the axle part, on one side of the brake disk 4 by means of a fixed part 6. The braking torques absorbed by the caliper 1 when the brake is actuated are carried off to the vehicle part 7 (axle part) via the fixed part 6. Especially when the so-called rim-side brake pad 3 has no separate guiding and supporting part for absorbing the peripheral braking forces, such as a brake carrier, but rather this brake pad is mounted directly on the free, unsupported caliper arm, the caliper 1 shows a greater tendency, when the brake is actuated, to become skewed in the direction of the brake disk run-out side, corresponding to the direction of rotation D of the brake disk 4.

This causes not only disadvantageous oblique wear of the rim-side brake pad 3 due to uneven brake lining contact, but also, depending on the caliper design of the disk brake, extreme loads on the guiding and supporting parts. These are the pin guides 8 or bearing pins in the case of a sliding caliper or hinged caliper, but the mounting flange in the case of a fixed caliper. Either the guiding or supporting devices for the caliper relative to the vehicle part must be designed correspondingly stable.

Since, especially in the case of disk brakes for commercial vehicles, very high braking torques are necessary for braking the vehicle, correspondingly expensive material dimensioning is necessary. However, disadvantageous caliper skewing cannot be entirely avoided even by this means.

Therefore, in the disk brake according to DE 197 43 538 with direct mounting of the brake pad on the free caliper arm (rim side), an attempt is made in the case of a sliding caliper to prevent skewing of the caliper by providing that a part of the brake carrier spans the brake disk with lateral guide arms to serve as a support/contact surface for the caliper, which is intended to prevent the caliper from skewing. However, a narrow guide tolerance limits the sliding function due to undesired friction torques by the caliper contact during the braking and releasing operation. High bending torques and friction torques on/in the guide bearings of the sliding caliper also have an unfavorable effect.

EP Patent 709 592 discloses another possible solution of the problem. It likewise proposes the guidance of the brake pad on the clamping side in the fixed part of the brake and of the brake pad on the rim side on the caliper arm, and guide pins are used to guide the caliper.

In the two prior-art solutions described above, the centers of gravity of the brake pads lie opposite each other relative to the brake disk. The brake pads thus lie symmetrically opposite each other.

Because the brake according to EP Patent 709 592 uses a more or less plate-shaped brake carrier, it would be a good choice for commercial vehicles simply because of its reduced weight, but disk brakes with this design, even small disk brakes and disk brakes used in passenger vehicles, suffer from enormous disadvantages, which manifest themselves mainly in skewing of the caliper. The consequences of this skewing are high bending torques, including friction torques, in the caliper guides (torques which oppose skewing of the caliper) and uneven rim-side lining contact with unfavorable tangential wear.

To meet the increasing requirements of the market on sliding or fixed calipers—such as weight savings and compact, service-friendly design—and at the same time ensure reliable brake function and brake stability, an effort must be made to develop a modern brake design while giving due consideration to the materials that are used.

For example, German Patent Application 102 41 157, which was filed on Sep. 5, 2005, provides an improvement of the brake disclosed in U.S. Pat. No. 5,022,500, in which skewing of the caliper is prevented by providing that the second center of gravity is offset from the first center of the gravity by a predetermined distance in the direction toward the run-out side of the brake disk, i.e., the side which trails when the brake disk is rotating in its preferred direction.

In other words, the brake according to German Patent Application 102 41 157 is designed to be “asymmetric” in a predetermined way. As a result, a torque corresponding to the amount of the offset between the two centers of gravity is produced, which opposes the torque on the side of the brake caliper connected to the fixed part of the axle. If the amount of offset is chosen suitably, the two torques cancel each other out; they “neutralize” each other. Therefore, if the amount of offset is chosen appropriately, caliper skewing is prevented, as a result of which the lining will make uniform contact with the disk, especially on the free side of the brake caliper. This results in a corresponding wear compensation. The guide pins do not have to produce a countertorque, which is associated with elevated friction torques, but rather only need to absorb the force that displaces the caliper and the torque that supports it. In cases where the caliper is of the sliding type, improved support is thus also provided for the sliding movement.

In this regard, it is irrelevant whether there is only a single friction element on each side of the brake disk, as described above on the basis of the functional example, or several individual brake pads/individual segments on each side of the brake disk, because the effect of producing a countertorque by means of an offset arrangement or arrangements can also be achieved with several brake pads.

This is also true for a hinged caliper, which can pivot about at least one bearing pin, as well as for a fixed caliper disk brake. As a result of the previously explained neutralization of the torques, there is also no longer any “crossing” (skewing) in the holding or mounting areas of the caliper, as a result of which savings in material and weight can also be achieved here due to the use of a smaller amount of material.

GB 1,066,442 discloses a disk brake in which the center axis of the clamping device encloses an acute angle with the principal plane of the brake disk.

Jp 09-032870 A discloses a disk brake in which the center axis of the clamping device does not pass through either the first center of gravity or the second center of gravity and in which these two centers of gravity are offset relative to each other.

The disk brake according to German Patent Application 102 41 157 will now be explained in greater detail.

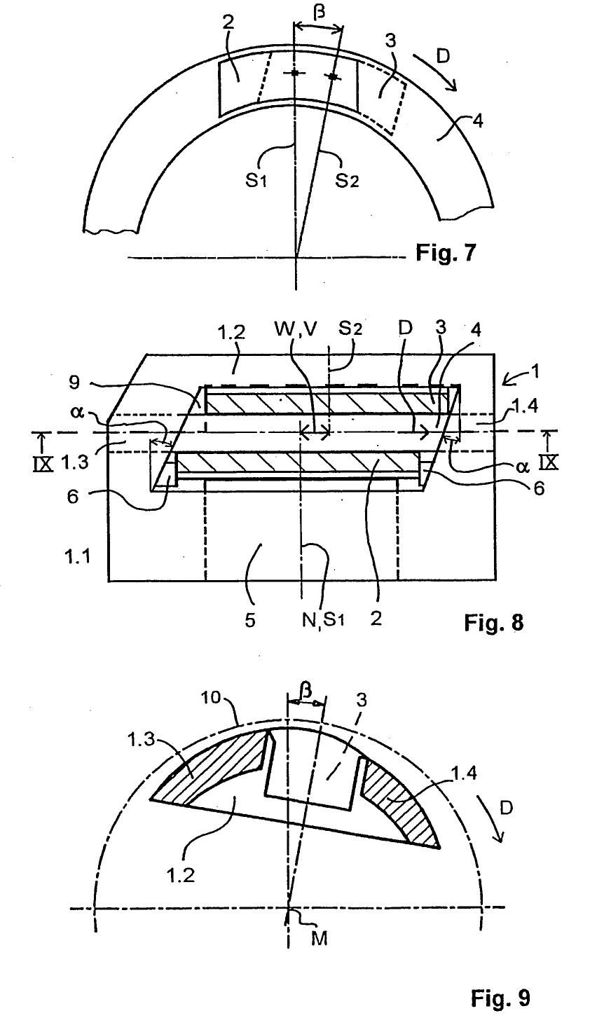

FIGS. 5 to 7 show schematic drawings of various embodiments.

To the extent that they are present, the reference numbers used in FIGS. 5 to 7 are the same as those used in FIGS. 1 to 4.

As FIGS. 5 to 7 show, the centers of gravity S1 and S2 do not coincide, but rather the center of gravity S2 of the brake pad 3 is offset relative to the center of gravity S1 of the brake pad 2 by the distance V towards the run-out side of the brake disk. This offset V is achieved either by shifting the brake pad 3 in a parallel direction or by arranging it in the free caliper arm in such a way that it is rotated about an angle β relative to the brake pad 2. In the latter case, the two centers of gravity S1 and S2 lie on an imaginary circular arc around the center axis of the brake disk 4. This design has the advantage that linings of the same design can be used on both sides of the brake disk. This eliminates the possibility, for example, that a lining could be installed on the wrong side.

The caliper 1 has a radial opening 9 in the bridge area that spans the area of the brake disk. In the top view of the caliper (FIG. 6), the contour of the radial opening 9 extends obliquely at an angle α in the direction of the lining offset V and is thus shaped more or less like a parallelogram.

The space available for the installation of the brake (usually within the wheel rim) is limited.

According to the introductory clause, the invention proceeds from a disk brake of the type disclosed in U.S. Pat. No. 4,632,227 A, which corresponds to EP 145 593 B1. In this previously known disk brake, each of the two struts of the caliper 10 has the same radial distance from the brake disk 18. However, no asymmetries are provided. Therefore, to realize the offset of the two brake linings relative to the clamping, it is necessary to widen the caliper. Otherwise, the two offset linings cannot be accommodated. Accordingly, the distance between the associated holding areas increases, as a result of which the caliper covers an enlarged circular sector area of the brake disk. In the top view, the caliper extends well beyond the width of the holding devices (here, for example, right-side guide pins on the disk run-out side).

Therefore, the caliper of the previously known disk brake is designed with a large area, which leads to correspondingly increased weight and to additional loads on the holding and guiding parts. Moreover, the goal of torque neutralization is not achieved to a satisfactory extent. In addition, the space required for installation increases.

The objective of the invention is to further develop and improve the disk brake according to U.S. Pat. No. 4,632,227 A (EP 145 593 B1) in such a way that especially the second (rim-side) brake pad is uniformly pressed against the brake disk.

In accordance with the invention, this objective is achieved by the features specified in the characterizing clause of new claim 1, especially by the different radial distances.

The invention thus makes it possible not just to minimize the second caliper arm with respect to the space required for its installation, but rather it also makes it possible for the caliper to transmit high clamping forces loss-free without widening it and, in the predetermined elasticity range, also to move in the preferred direction of rotation of the disk during braking without any danger of collision with the brake disk or a wheel rim surrounding the brake.

Due to the described asymmetry on the second side (rim area), the caliper moves radially inward and thus presses the second brake pad uniformly against the brake disk. This causes uniform heat input into the brake disk, which increases the life of the braking period, because it eliminates unfavorable effects that would otherwise lead to overheating of the brake disk and to the formation of heat cracks.

Finally, the design of the invention results in the compensation of torques, so that the caliper is subject overall to fewer torques. Therefore, it can be designed with less strength, which results in savings with respect to weight and installation space.

It is preferred for the offset of the two caliper arms to equal the offset of the two centers of gravity of the brake pads or the offset of the brake pads. This results in optimum operating conditions.

In accordance with the invention, it is further preferred as especially mechanically advantageous for the two centers of gravity to be the same radial distance from the center axis of the brake disk. In other words, the two centers of gravity have a defined angular separation around the center of the brake disk.

An offset of the second center of gravity relative to the first center of gravity in the direction parallel to the brake disk can be based at least partially on an offset of the second brake pad relative to the first brake pad parallel to the brake disk. In other words, this design of the invention provides that the brake pads themselves, not just their centers of gravity, are arranged in an offset manner relative to each other.

To ensure symmetrical clamping on the clamping side, it is preferred, in accordance with the invention, for the center axis of the clamping device to pass through the first center of gravity.

To guarantee complete contact of the second brake pad on the brake disk despite the offset, but also for reasons of symmetry, the second brake pad is rotated relative to the first brake pad. In accordance with the invention, therefore, it is preferred for the area of the second caliper arm that rests against the second brake pad also to be rotationally staggered relative to the area of the first caliper arm that rests against the first brake pad.

In this regard, it is also preferred, in accordance with the invention, for the area of the second caliper arm that rests against the second brake pad to be rotated about the axis of rotation of the brake disk relative to the area of the first caliper arm that rests against the first brake pad. This corresponds to the embodiment in which, despite the offset, the two centers of gravity have the same radial distance from the center axis of the brake disk.

Especially for the purpose of achieving material savings, it can be provided, in accordance with the invention, for the connecting device to have an opening in the area that spans the brake disk.

In accordance with the invention, to allow better placement of the brake pads, the opening preferably extends over the first and/or second brake pad in the projection parallel to the brake disk.

In this regard, the contour of the opening is more or less that of a parallelogram, so that, especially in the case of brake pads that are arranged in an offset manner relative to each other, the width of the opening that is to be adapted to the offset and thus the total width of the caliper are minimized. At the same time, strut areas on the caliper, which are essentially triangular, are obtained on both sides of the opening, which results in greater caliper rigidity. The words “more or less”, as used above, are intended to indicate that opposite sides of the “parallelogram” do not necessarily have to be exactly parallel to each other, but rather that the opening can also have the contour of a skewed parallelogram, in which, for example, only the boundaries that are parallel to the brake disk are parallel to each other.

Alternatively, it can also be provided that, in the projection parallel to the brake disk, the opening can have a concave contour on the brake disk run-in side and a more or less linear contour on the brake run-out side. This more or less linear contour forms an acute or obtuse angle with the plane of the brake disk. In this way, the strength properties of the caliper can be optimized with respect to the stresses it can withstand.

In another alternative, the opening in the projection parallel to the brake disk can have a concave contour on both the brake disk run-out side and the brake disk run-in side. In this embodiment, the contour can be set at an angle α—similar to a parallelogram.

In an especially preferred embodiment of the invention, the part of the connecting device that is located on the brake disk run-out side with respect to the opening has a smaller cross section in a plane parallel to the brake disk than the part of the connecting device that is located on the brake disk run-in side.

The outer contours of the caliper on the brake disk run-in side and the brake disk run-out side are preferably more or less parallel to each other and, also preferably, perpendicular to the plane of the brake disk. This makes it possible to minimize the width of the caliper, so that the space required for installation is reduced.

This embodiment results in further material savings and at the same time ensures that the caliper can also move in the preferred direction of rotation of the disk during braking. This results in the advantages that have already been described above.

In accordance with the invention, the brake is preferably provided with a plate-shaped support structure, so that material savings are also realized here. It is possible to use a plate-shaped support structure, because, in accordance with the invention, the torques are neutralized.

In accordance with the invention, the support structure is also preferably designed as an integral part of the axle part.

As has already been noted, the disk brake of the invention is preferably a sliding caliper disk brake, a hinged caliper disk brake, or a fixed caliper disk brake with one-sided or two-sided clamping.

The brake of the invention is preferably pneumatically and/or electromotively actuated.

Finally, in accordance with the invention, the brake of the invention is preferably designed for installation in commercial vehicles.

The invention is explained in greater detail below on the basis of the specific embodiments illustrated in the accompanying drawings.

FIG. 8 shows a view of a preferred embodiment of the invention, which corresponds to the view in FIG. 6.

FIG. 9 shows a sectional view along line IX/IX in FIG. 8.

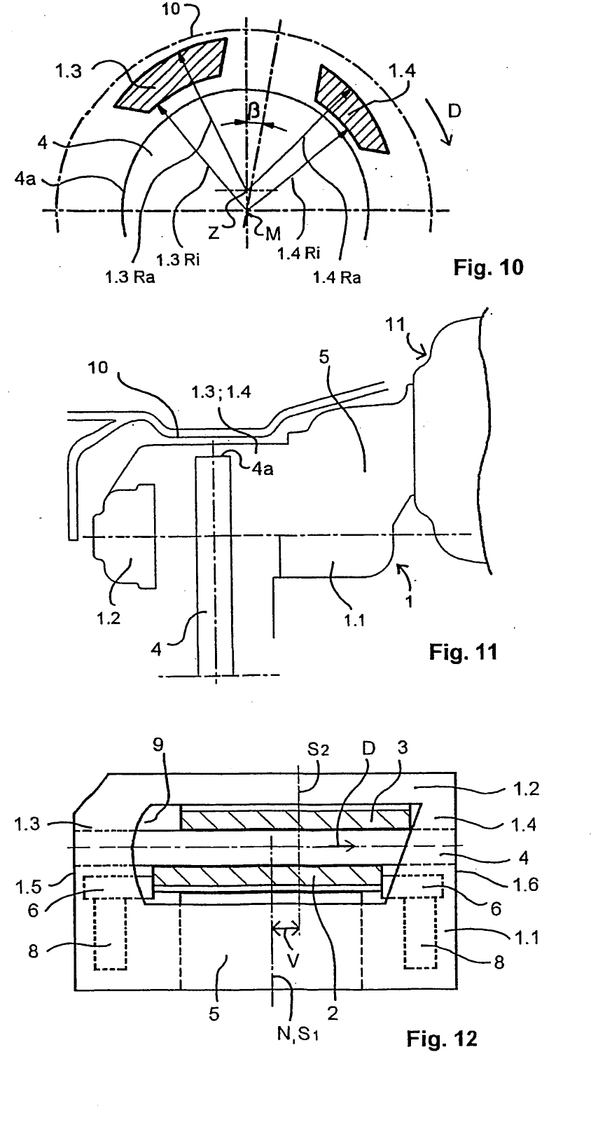

FIG. 10 shows the same view as FIG. 9 but without the brake pad 3.

FIG. 11 shows a schematic drawing of the disk brake according to FIGS. 8 to 10 in its installed position in the wheel rim.

FIG. 12 shows an alternative embodiment in the same view as FIG. 8.

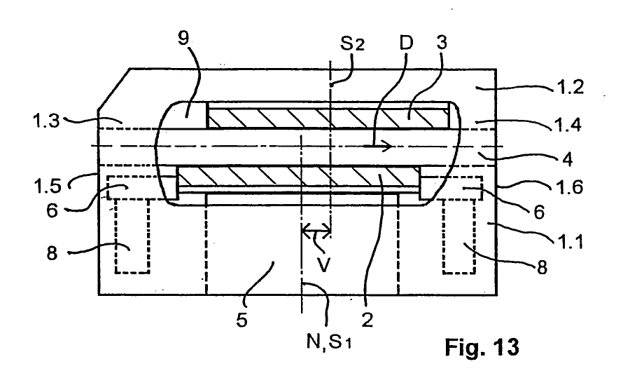

FIG. 13 shows another alternative embodiment in the same view as FIG. 8.

FIG. 8 shows the caliper arm 1.1 on the mounting side; here, it also supports the clamping device 5. The rim-side caliper arm 1.2 is also shown. Both arms are joined by bridge areas/bridge struts 1.3, 1.4. The bridge strut 1.3 is located on the run-in side in the direction of rotation D of the brake disk 4, and the bridge strut 1.4 is located on the run-out side. As is apparent especially from FIG. 9, the bridge strut 1.4 is designed less robustly than the bridge strut 1.3, which improves the torsional elasticity of the caliper.

The center axis N of the clamping device 5 coincides with the center of gravity or the centroidal axis S1 of the clamping- side brake pad 2.

The rim-side caliper arm 1.2 is offset by a distance W from the clamping-side caliper arm 1.1. The distance W corresponds to the distance V of the offset of the two brake pads 2 and 3 relative to each other.

In contrast to the brake design according to FIG. 6, the offset W of the rim-side caliper arm 1.2 results in savings of the caliper material. This is indicated schematically in FIG. 8 by the sloped surface at the upper left, which does not appear in FIG. 6. This material savings makes the brake lighter. In addition, the brake requires less space for installation due to this sloped surface.

FIG. 9 shows the rim-side caliper arm 1.2 for mounting the rim-side brake pad 3 with the chamfered, twisted, or turned struts 1.3, 1.4 and their positions in relation to a wheel rim 10. The rim-side caliper arm is rotated at an angle β relative to the mounting side.

Support strips (not shown), which are formed radially inward and laterally towards both ends of the lining, serve to mount the offset and/or rotated rim-side brake lining 3 in the rim-side caliper arm 1.2. This creates an installation “shaft” on which the lining is supported or laterally mounted. In this way, the lining can be immediately placed in a well-defined installed position through the radial opening. The struts 1.3, 1.4 for joining the two caliper arms 1.1 and 1.2 are twisted or turned and have different designs, which then lead to an altered position of the caliper arm 1.2 relative to the caliper arm 1.1. They are produced by (different) predetermined constructional dimensional specifications for the caliper design with different radii and their combination in FIG. 10, according to the specific intended use of the brake.

FIG. 10 shows the positions of the struts 1.3 and 1.4 not only in relation to the wheel rim 10 but also in relation to the brake disk 4. As especially FIG. 10 shows, the radii 1.3 Ri, 1.3 Ra, 1.4 Ri, and 1.4 Ra are different not only in magnitude but also with respect to their imaginary origins. For example, the imaginary origin Z of the radii 1.3 Ra and 1.4 Ra is offset from the center axis M of the brake disk 4. As can be seen in FIG. 10, the struts 1.3 and 1.4 run between the calipers 1.1 and 1.2 axially over the outer circumference 4a of the brake disk and join the two caliper arms. The position of the struts relative to the specified radii are radial distances.

The struts have different strut thicknesses and/or cross sections, which is why they also have different radial distances relative to the wheel rim and the brake disk, which are produced by combining different outer and/or inner radii. Additionally or alternatively, different strut widths can also be produced by the special shaping of the radial opening 9 of the caliper, which then, not only in connection with the different strut cross sections, influence the strength of the caliper itself as well as the effectiveness or the transmission of the desired countertorque or of a balance of torques.

FIG. 11 shows, with reference to the drawings discussed above, the very limited space for the installation of brakes of commercial vehicles. Reference number 11 refers to an actuating cylinder. The disk brakes illustrated in the drawing are pneumatically and/or electromotively actuated disk brakes for commercial vehicles.

No fixed values can be given for the offsets V and W, but rather the offset V is mathematically calculated for the purposeful generation of the required countertorque according to the given circumstances and depends on the coefficient of friction (matching/combination of the coefficients of friction of the brake lining and the brake disk) and on the geometry of the brake (size of the brake/brake disk). These are ultimately dependent on the specific intended use of the disk brake.

The same is also true for the offset angle β. This angle is also mathematically determined and depends on the diameter of the brake disk and on the geometry of the brake. Here, too, it is necessary to consider the specific intended use of the disk brake.

FIG. 12 shows the same view as FIG. 8 but for an alternative embodiment. It differs from the embodiment shown in FIG. 8 especially in the design of the radial opening 9, by which improved strength properties are obtained in connection with the strut designs explained above with respect to the rotational staggering of the caliper. In the projection or top view of the caliper 1, the radial opening 9 is designed in such a way that the bridge strut 1.3 on the disk run-in side runs concavely between the caliper arms 1.1 and 1.2, and the bridge strut 1.4 on the disk run-out side runs, as in FIGS. 6 and 8, at an angle α with respect to the plane of the brake disk. In addition to the different radial distances and/or strut cross sections, different bridge widths are thus also produced, so that the strength properties of the caliper are optimized with respect to the stresses it can withstand due to the special shaping.

FIG. 13 shows another alternative embodiment in the same view as FIG. 8. The embodiment of FIG. 13 is essentially the same as that of FIG. 12, but the contour 9 of the bridge strut 1.4 on the disk run-out side runs concavely between the caliper arms 1.1 and 1.2. In addition, the concave contour can also be set at an angle α—as in the drawings shown/described above. Accordingly, in the regions of the bridge struts, depending on the position of the cutting plane, special cross-sectional contours are produced, which once again result in improved strength properties of the caliper with respect to the stresses it can withstand in connection with material/weight savings due to their shaping and/or in conjunction with the radius combinations according to FIG. 10 and the again harmonized transition regions within the radial opening 9.

As is also clearly seen here, despite the rotationally staggered caliper design, the two outer caliper contours 1.5, 1.6, which define the caliper width, run more or less parallel to each other, specifically, from the clamping side over the outer circumference of the brake disk to the caliper arm on the opposite side. In other words, despite the rotational staggering of the arms, the caliper itself does not run obliquely in its width in the direction of rotation D of the brake disk. It thus has a narrower construction compared to the prior art and thus covers a significantly smaller circular sector area.

Naturally, the aforementioned parallelism of the sides is also present in the other illustrated caliper designs.

The features of the invention disclosed in the above specification and in the claims and drawings can be essential, both individually and in any combination, for realizing the invention in its various embodiments.

1. Disk brake with
a brake disk (4) that has a preferred direction of rotation (D);
a first brake pad (2) with a first center of gravity (S1) on a first side of the brake disk (4);
a second brake pad (3) with a second center of gravity (S2) on a second side of the brake disk (4);
a caliper (1) for transmitting the braking forces generated by the second brake pad (3) to the first side of the brake disk (4), with a first caliper arm (1.1) on the first side of the brake disk (4), a second caliper arm (1.2) on the second side of the brake disk (4), and a connecting device (1.3, 1.4) for joining the first caliper arm (1.1) with the second caliper arm (1.2); and
a clamping device (5), which has a center axis (N) perpendicular to the brake disk (4) and is designed to force the first brake pad (2) against the brake disk (4); wherein
the second center of gravity (S2), both in the position of rest of the brake and when the brake is actuated, is offset relative to the first center of gravity (S i) by a predetermined first distance (V) in the direction of a brake disk run-out side corresponding to the preferred direction of rotation (D) of the brake disk (4), and
the second caliper arm (1.2) is offset relative to the first caliper arm (1.1) by a predetermined second distance (W) in the direction of the brake disk run-out side, wherein
the connecting device (1,3, 1.4) is radially closer to the brake disk (4) on the brake disk run-out side than on a brake disk run-in side, at least in the region in which it spans the brake disk (4).

2. Disk brake in accordance with claim 1, wherein two centers of gravity (S1, S2) have the same radial distance from the center axis (M) of the brake disk (4).

3. Disk brake in accordance with claim 1, wherein an offset (V) of the second center of gravity (S2) relative to the first center of gravity (S1) in the direction parallel to the brake disk (4) is based at least partially on an offset of the second brake pad (3) relative to the first brake pad (2) parallel to the brake disk (4).

4. Disk brake in accordance with claim 1, wherein the center axis (N) of the clamping device (5) passes through the first center of gravity (S1).

5. Disk brake in accordance with claim 1, wherein the area of the second caliper arm (1.2) that rests against the second brake pad (3) is rotationally staggered relative to the area of the first caliper arm (1.1) that rests against the first brake pad (2).

6. Disk brake in accordance with claim 1, wherein the area of the second caliper arm (1.2) that rests against the second brake pad (3) is rotated about the axis of rotation (M) of the brake disk (4) relative to the area of the first caliper arm (1.1) that rests against the first brake pad (2).

7. Disk brake in accordance with claim 1, wherein the connecting device (1.3, 1.4) has an opening (9) in the area that spans the brake disk (4).

8. Disk brake in accordance with claim 7, wherein the opening (9) extends over the first and/or second brake pad (2, 3) in the projection parallel to the brake disk (4).

9. Disk brake in accordance with claim 1, wherein the contour of the opening (9) is more or less that of a parallelogram.

10. Disk brake in accordance with claim 1, wherein, in the projection parallel to the brake disk (4), the opening (9) has a concave contour on the brake disk run-in side and a more or less linear contour on the brake disk run-out side, and that this more or less linear contour forms an acute or obtuse angle (α) with the plane of the brake disk.

11. Disk brake in accordance with claim 1, wherein the opening (9) in the projection parallel to the brake disk (4) has a concave contour on both the brake disk run-in side and the brake disk run-out side.

12. Disk brake in accordance with claim 1, wherein the part (1.4) of the connecting device (1.3, 1.4) that is located on the brake disk run-out side with respect to the opening (9) has a smaller cross section in a plane parallel to the brake disk (4) than the part (1.3) of the connecting device (1.3, 1.4) that is located on the brake disk run-in side.

13. Disk brake in accordance with claim 1, wherein the outer contours (1.5. 1.6) of the caliper (1) on the brake disk run-in side and the brake disk run-out side are more or less parallel to each other and preferably perpendicular to the plane of the brake disk.

14. Disk brake in accordance with claim 1, comprising a plate-shaped support structure (6).

15. Disk brake in accordance with claim 1, wherein it is pneumatically and/or electromotively actuated.

16. Disk brake in accordance with claim 1, wherein it is a brake for use in commercial vehicles.
